(19) United States
(12) Patent Application Publication
(10) Pub. No.: US 2011/0126796 A1
(43) Pub. Date: Jun. 2, 2011

(54) System For Supplying An Internal Combustion Engine

(76) Inventor: Marco Ciaccini, Umbertide Perugia (IT)

(21) Appl. No.: 13/056,386

(22) PCT Filed: Jul. 23, 2009
(86) PCT No.: PCT/EP2009/059458

§ 371 Date: Jan. 28, 2011

(30) Foreign Application Priority Data
Jul. 28, 2008 (IT) PG2008A 000035

(51) Int. Cl. F02B 47/02; F01N 5/02

(52) U.S. Cl. 123/25 P; 60/320

(57) ABSTRACT

The system for supplying an internal combustion engine can combine a traditional plant for fuel injection with a steam injection plant; the steam injection plant sourcing water from a tank (1) therefor, in order to generate water steam by exploiting the exhaust gas heat. A steam injection control unit (6) injects the steam during the engine aspiration stage. The system reduces fuel consumption and drastically reduces pollutant agents.

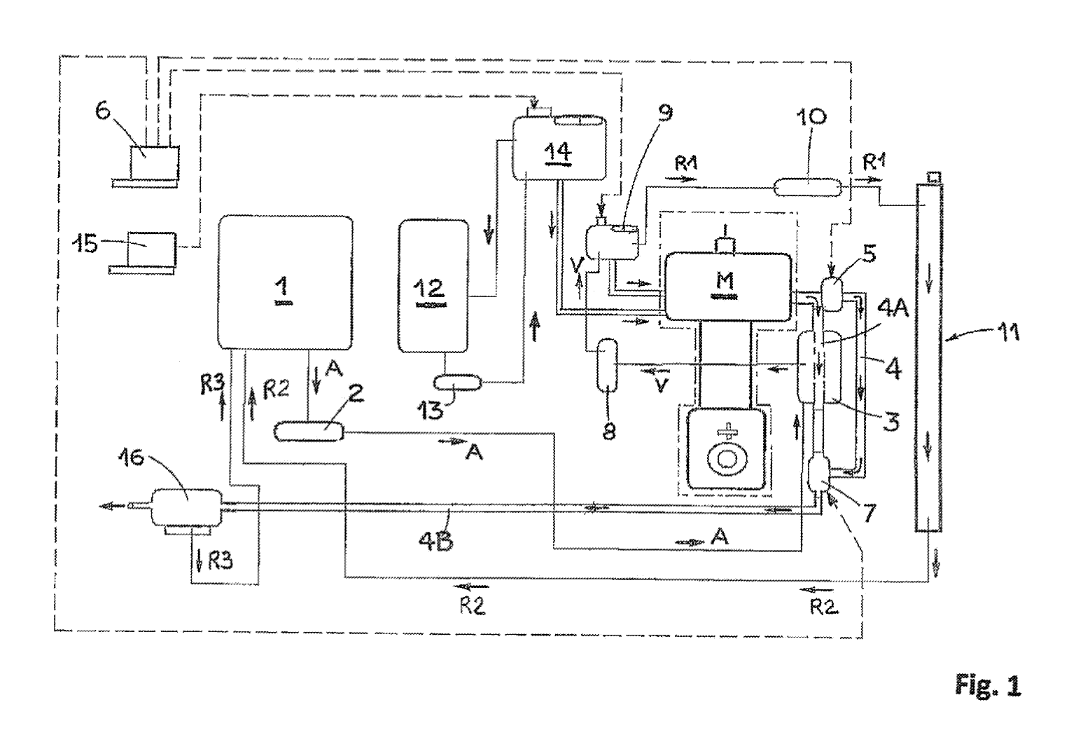

### FIELD OF THE INVENTION

The invention relates to the technical sector concerning internal combustion engine.

### SUMMARY OF THE INVENTION

The aim of the invention is to realize a system for supplying an internal combustion engine that reduces fuel consumption and pollutant agents.

The set aim is attained in accordance with the contents of the independent claim.

### BRIEF DESCRIPTION OF THE DRAWING

The FIGURE of the drawing schematically represents an internal combustion engine M provided with components which in a technical-functional combination thereof define the system which is the object of the present invention.

### BEST MODE FOR CARRYING OUT THE INVENTION

The system comprises two separate injection plants, one for water steam and one for fuel, the fuel injection system being constituted, substantially, by normal series fuel plant.

The plants cooperate, in a suitable phase relation, in the functioning of the engine M.

In the first injection plant, normal water is loaded into a water tank 1 and, via a pump 2, is injected into a tube which takes it (arrows A) to a reaction chamber 3.

As is known, during functioning exhaust gases are expelled from the exhaust manifold 4 of the engine M, the exhaust gases having temperatures comprised between 350 and 900 degrees Celsius.

The reaction chamber 3 is a sealed body containing the water brought from the pump 2, enveloping an offtake 4A of the exhaust manifold 4; thus the reaction chamber 3 defines a heat exchanger.

The gases which are indirectly in metallic contact with the reaction chamber 3 overheat the water and increase the pressure and temperature thereof, causing it to pass from the liquid phase into the gas phase.

The result of the overheating is steam, which has temperature and pressure properties which are regulated by various electromechanical valves.

All of the valve and steam actuator regulations are performed by a steam injection control unit 6 constituted by a computer with a microchip and a hard disk.

The steam injection control unit 6 exhibits data reading channels connected with various sensors (not illustrated) and enables data to be acquired in real-time, the data being temperature, pressure, rotating speed etc.

When the data has been obtained, calculations are made in times and lengths for piloting the actuators and valves.

The reading, calculating and piloting operations regulate the functioning of all the steam part within the preset ranges, and consequently regulate a part of the performance of the engine M.

The exhaust gas flow valve 5, located upstream of the offtake 4A, is controlled by the steam injection control unit 6 to regulate the quantity of the exhaust gases channel into the offtake 4A to heat the reaction chamber 3; if anomalous temperatures are detected in the reaction chamber 3, the flow valve 5 partialises or stops passage of gases through the offtake 4A, directing them into the exhaust manifold 4.

The exhaust gas block valve 7, located downstream of the branch 4A, is commanded by the steam injection control unit 6 to regulate the outflow of the exhaust gases coming from the offtake 4A and replace them in the exhaust pipe 4B, on exiting the manifold 4.

The steam pressure regulator 8 regulates the temperature and pressure of the steam exiting from the reaction chamber 3, taking the steam, at a more or less constant temperature, to the steam injection command unit 9 (see arrows V).

The steam injection command unit 9 injects the steam produced by the reaction chamber 3 during the stage of aspiration, and associates the stem to the fuel in quantities and at times which, according to the conditions, are preset by the steam injection control unit 6.

The non-injected excess steam produced by the reaction chamber 3 is expelled by the steam injection command unit 9 in quantities and at 25 pressures which are regulated by the steam expeller 10 (see arrows R1).

The steam expeller 10 selects the pressure and temperatures of the excess steam and channels the steam into a special tubing connected at an end thereof to the steam cooling radiator 11.

The steam crosses the steam cooling radiator 11, its pressure and temperature thus lowering until it is returned to the liquid phase.

The water exiting the steam cooling radiator 11 is recycled and returns to the water tank 1 (arrows R2).

The fuel injection plant comprises, in a known way, a tank 12 and a pump 13 which supplies an injection command 14.

The injection command 14 injects the fuel during the aspiration stage of the engine M and is piloted in times and moments by a relative injection control unit 15.

The injection control unit 15, like the steam injection control unit 6, comprises data reading channels connected with various sensors and enables acquisition of data in real-time, such as temperature, pressure, rotating speed etc.

When the data has been obtained, the injection control unit 15 processes it in times and lengths for piloting the actuators and valves. The reading operations, calculation and piloting regulate the functioning of all the fuel part within the preset ranges.

As with the steam injection plant, the excess fuel not injected by the injection command 14 is returned via a tube to the tank 12.

The steam injection plant, in a preferred embodiment thereof, is provided with a final steam collection device 16, positioned in proximity of the exhaust terminal, which recuperates the final condensation formed therein, returning it to the water tank 1 (arrows R3).

The water steam and fuel are associated in percentages thereof and injected into the internal combustion engine during the aspiration stage. Though they are compressed together, the combustion is produced only by the traditional fuel.

In the combustion chamber, during combustion, specific temperatures of from 600 to 1000 degrees Celsius are reached.

The water steam compressed in the combustion chamber generates enormous pressures which push the pistons during the exhaust stage.

The evaporation and pressure generation times between the steam and the combustion temperatures are almost instantaneous.

The injected steam lowers the temperatures in the combustion chamber, and the thermal yield of the engine is consequently increased.

The correct association of quantities of the steam and fuel drastically reduces the pollution levels.

The specific unit quantity of fuel used in association with water steam is drastically reduced in comparison with traditional engines, for a same thermal yield.

The water steam does not pollute and by creating it in the reaction chamber 3 part of the heat associated to the waste products of an internal combustion engine and the exhaust gases is recuperated.

All types of water can be used, including waste water, as the solid impurities therein can be separated during vaporisation in the reaction chamber 3.

The invention, concerning a supply system of an internal combustion engine, can be applied to internal combustion engines for vehicles, work machines, transport, turbines, generators, pumps, compressors etc.

No re-designing or large-scale structural modifications are necessary for the industrial producers of internal combustion engines; indeed the re-use of designs otherwise considered obsolete (as being too pollutant) is possible.

The invention can give rise to a specific conversion kit for models already present on the market, considerably increasing the working life and use of internal combustion engines.

It can provide a fresh design departure for new models without having to modify the fuel distribution system.

The prototype of the invention which has been constructed and tested has provided performance levels hitherto unknown for internal combustion engines, both in terms of consumption and performance, not to mention the very small quantities of noxious powders expelled.

The application fields can be found in all the solutions where there is an internal combustion engine.

A rapid and easy installation, certainly relatively very inexpensive, can eliminate and improve many of the problems connected to all internal combustion engines.

1. A system for supplying an internal combustion engine having at least a cylinder, including a fuel injection plant, comprising an injection control unit (15), destined to pilot at least an injection command (14) for introducing batched quantities of fuel internally of the cylinder, in a phase relation with an aspiration, the system including a steam injection plant comprising:
means (3) for generating and storing the steam in sufficient quantities for ensuring a continuous availability thereof;
a steam injection command unit (9), supplied with steam at a controlled pressure, sourcing from the means (3) for generating the steam, and destined to introduce batched quantities of the steam internally of the cylinder;
a steam injection control unit (6) provided for controlling and piloting the means for generating and storing (3) the steam for supplying the steam to the steam injection command unit (9), as well as for piloting the steam injection command unit (9) in order for the introduction of steam into the cylinder to be done in a phase relation with the aspiration and with the injection of fuel, such that it cooperates with the fuel in order to determine a thrust on a piston of the cylinder, in an active stage of the cycle, following a combustion of the fuel.

2. The engine of claim 1, wherein the means (3) for generating and storing the steam comprise a water tank (1) containing water and a pump (2) for removing the water and sending the water to a reaction chamber (3), in which reaction chamber (3) the water is heated up to vaporizing, resulting steam being sent to the steam injection command unit (9).

3. The system of claim 2, wherein the reaction chamber (3) comprises a heat exchanger, which uses exhaust gases from the engine (M) for the vaporizing of the water.

4. The system of claim 2, wherein the reaction chamber (3) is conformed such as to envelop an offtake (4A) realised in an exhaust manifold (4) of the cylinder, which offtake (4A) opens into an exhaust pipe (4B) at an outlet of the manifold (4).

5. The system of claim 4, further comprising an exhaust gas flow valve (5) located upstream of the offtake (4A), which flow valve (5) is commanded by the steam injection control unit (6) in order to regulate the quantity of exhaust gases channeled into the offtake (4A) for heating the reaction chamber (3), and in that an exhaust gas block valve (7) is located downstream of the offtake (4A), which block valve (7) is commanded by the steam injection control unit (6) for regulating the outflow of exhaust gases from the offtake (4A) towards the exhaust pipe (4B).

6. The system of claim 1, further comprising a steam pressure regulator (8), interposed between the reaction chamber (3) of the means for generating and storing steam and the steam injection command unit (9), the steam pressure regulator (8) maintaining a substantially constant supply pressure of the steam delivered to the steam injection command unit (9).

7. The system of claim 1, further comprising a steam expeller (10), associated to the steam injection command unit (9), for intercepting excess steam which has flowed into the steam injection command unit (9), and to divert the excess steam through a pipe to a steam cooling radiator (11) in which the steam is returned to the liquid state and is then sent to the water tank (1).

8. The system of claim 1, further comprising a final steam collection device (16), positioned in proximity of a discharge terminal of the engine (M) for collecting final condensation that has formed in the discharge terminal and for sending the condensation into the water tank (1).

9. The system of claim 3, wherein the reaction chamber (3) is conformed such as to envelop an offtake (4A) realised in an exhaust manifold (4) of the cylinder, which offtake (4A) opens into an exhaust pipe (4B) at an outlet of the manifold (4).

10. The system of claim 2, further comprising a steam pressure regulator (8), interposed between the reaction chamber (3) of the means for generating and storing steam and the steam injection command unit (9), the steam pressure regulator (8) maintaining a substantially constant supply pressure of the steam delivered to the steam injection command unit (9).

11. The system of claim 2, further comprising a steam expeller (10), associated to the steam injection command unit (9), for intercepting excess steam which has flowed into the steam injection command unit (9), and to divert the excess steam through a pipe to a steam cooling radiator (11) in which the steam is returned to the liquid state and is then sent to the water tank (1).

12. The system of claim 2, further comprising a final steam collection device (16), positioned in proximity of a discharge terminal of the engine (M) for collecting final condensation that has formed in the discharge terminal and for sending the condensation into the water tank (1).
